(19) United States
(12) Patent Application Publication
(10) Pub. No.: US 2026/0328420 A1
(43) Pub. Date: Oct. 22, 2026

(54) CYLINDER-SHAPED DEHUMIDIFIER WITH VORTEX AIRFLOW, THERMOSTAT CONTROL, AND MULTI-SOURCE POWER FOR WATER EXTRACTION

(71) Applicants: David William Christ, Staunton, VA (US); Lynette Rene Christ, Staunton, VA (US)

(72) Inventors: David Christ, Staunton, VA (US); Lynette Rene Christ, Staunton, VA (US)

(21) Appl. No.: 19/305,548

(22) Filed: Aug. 20, 2025

Related U.S. Application Data
(63) Continuation-in-part of application No. 18/944,447, filed on Nov. 12, 2024.

(51) Int. Cl. F24F 11/43; B01D 53/26; F24F 1/0083; F24F 11/83; F24F 110/10; F24F 110/20

(52) U.S. Cl. CPC F24F 11/43; B01D 53/265; F24F 1/0083; F24F 11/83; B01D 2257/80; F24F 2110/10; F24F 2110/20

(57) ABSTRACT

A cylinder-shaped dehumidifier configured to extract water from atmospheric humidity using a vortex airflow pathway and a condensation coil or rod assembly cooled by a thermostat-controlled refrigerant loop. A low-power fan draws humid air into a cylindrical housing where the air circulates in a vortex pattern around cooled condensation surfaces, causing water vapor to condense into droplets. A thermostat monitors ambient temperature and humidity and regulates refrigerant temperature to maintain optimal condensation while preventing coil freezing and minimizing energy consumption. An adjustable discharge port controls the residence time of air within the cylindrical housing to maximize removal of water vapor prior to exhaust. The condensed water is collected in a reservoir and directed to external storage and optional filtration. The system supports multiple power sources including solar, wind, battery, and AC/DC electrical inputs. The design supports modular scaling and accommodates different refrigerants based on geographical availability, enabling versatile deployment for efficient clean water generation in diverse environments.

### CROSS-REFERENCE TO RELATED APPLICATIONS

This application is a continuation-in-part of U.S. application Ser. No. 19/305,548, filed Aug. 20, 2025, which is a continuation-in-part of U.S. application Ser. No. 18/944,447, filed Nov. 12, 2024, entitled “Cylinder-Shaped Dehumidifier with Vortex Airflow, Thermostat Control and Multi-Source Power for Water Extraction.”

### FIELD OF THE INVENTION

The present invention relates to atmospheric water extraction systems, specifically to a cylinder-shaped dehumidifier that utilizes vortex airflow, thermostat-controlled refrigerant coils or rods, and multi-source power inputs to efficiently extract water from ambient humidity.

### BACKGROUND OF THE INVENTION

Conventional dehumidifiers and atmospheric water generators are typically limited in efficiency, energy usage, and water output. Many systems lack adaptability to varying environmental conditions and often require continuous high-energy input to function effectively. Existing designs also struggle with scaling production and often rely on a single energy source. The present invention addresses these challenges by introducing a vortex airflow design combined with thermostat-regulated cooling and multiple power options, enabling superior water production with lower energy consumption.

### SUMMARY OF THE INVENTION

The invention provides a cylinder-shaped dehumidifier designed for efficient extraction of water from atmospheric humidity. A low-power fan draws humid air into the cylinder, where it circulates around condensation coils or rods in a vortex pattern. These coils are connected to a thermostat-controlled refrigerant loop, preventing freezing while maintaining optimal condensation. Water droplets form on the cold surfaces, are collected in a reservoir, and routed to external storage. The system supports multiple power sources, including solar, wind, battery, and AC/DC input. Different refrigerants can be used based on geographical availability.

### BRIEF DESCRIPTION OF THE DRAWINGS

FIG. 1 illustrates a perspective view of the cylinder-shaped dehumidifier showing major components.

FIG. 2 shows an internal cross-section of the cylinder-shape dehumidifier illustrating the vortex/spiraling airflow and condensation rods.

FIG. 3 shows the condensation coils and refrigerant loop with thermostat control.

FIG. 4 shows multi-power source energy system connecting to the cylinder-shaped dehumidifier.

FIG. 5 illustrates the water collection, drainage, filtration and storage.

### DETAILED DESCRIPTION OF THE INVENTION

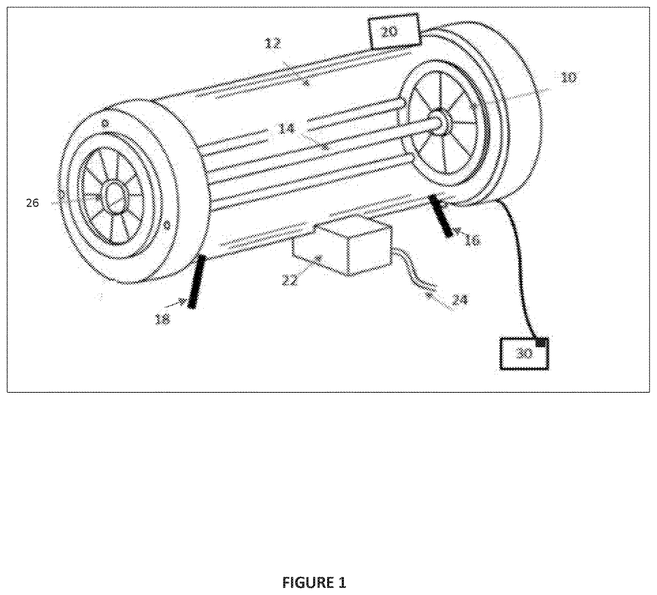

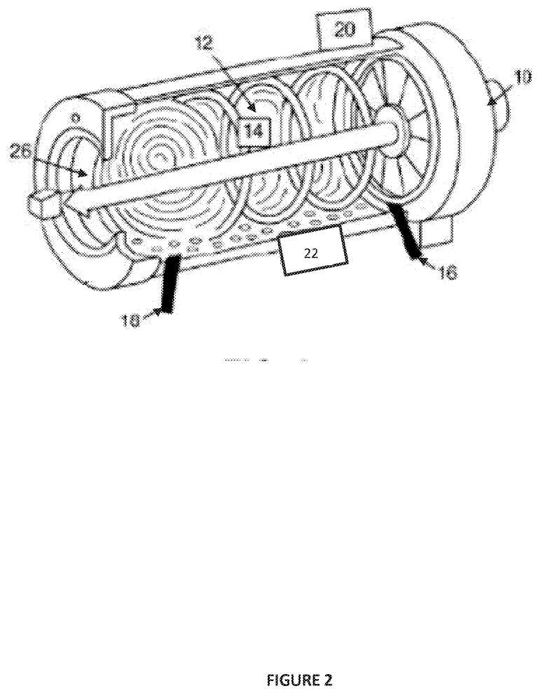

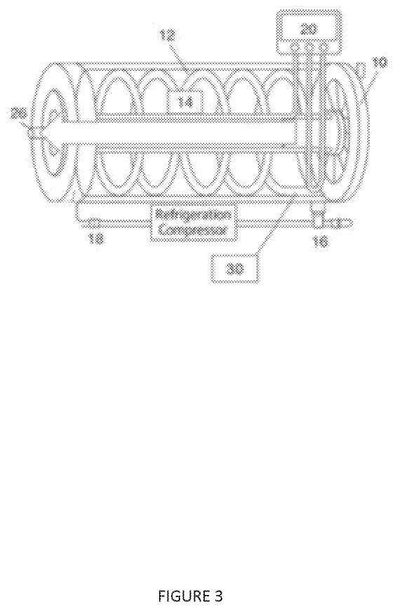

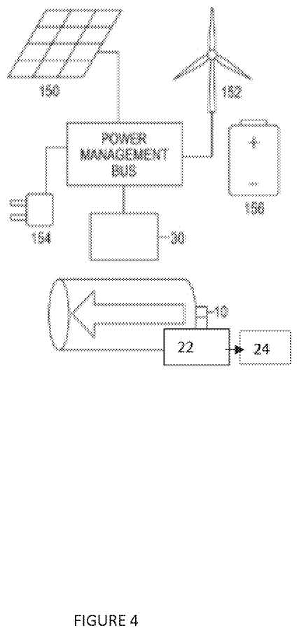

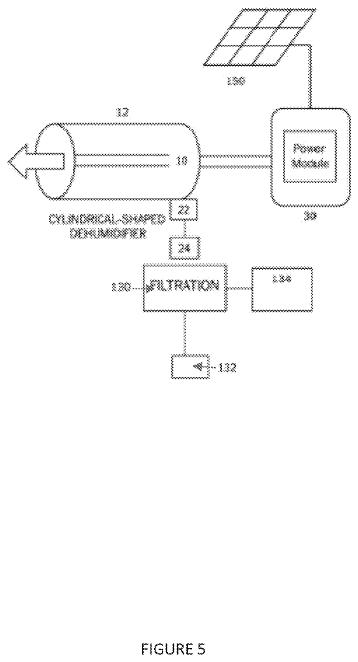

Referring to FIG. 1 through FIG. 5, the cylinder-shaped dehumidifier comprises a cylindrical housing configured to draw humid air through a low-power fan (Ref. No. 10). Inside the housing, a spiral-grooved inner surface (Ref. No. 12) induces a vortex airflow pattern around condensation coils or rods (Ref. No. 14). These coils are connected to a refrigerant loop (Ref. Nos. 16 & 18) regulated by a thermostat (Ref. No. 20), that continues to adapt to external humidity and temperature to prevent freezing and maximize water vapor to condensation efficiency. As humid air flows around the coils, water droplets condense and are collected in a reservoir (Ref. No. 22) at the bottom of the cylinder. A drainage outlet (Ref. No. 24) directs water to external collection tanks. An adjustable discharge port (Ref. No. 26) ensures maximum humidity removal before air exits the system. Multiple power sources can be connected (Ref. No. 30), including solar panels, wind turbines, batteries, and AC/DC inputs. Different refrigerants may be selected based on local supply and climate conditions, enhancing adaptability for diverse environments.

REFERENCE LIST

| | |
|---|---|
| 10 | Intake Fan |
| 12 | Cylinder Housing |
| 14 | Condensation Rods/Coils |
| 16 | Refrigerant Line-In |
| 18 | Refrigerant Line-Out |
| 20 | Thermostat |
| 22 | Reservoir |
| 24 | Drain Outlet |
| 26 | Adjustable Discharge Port |
| 30 | Power Module |
| 130 | Filtration Unit |
| 132 | UV Sterilization Module |
| 134 | External Storage Tank |
| 150 | Solar Panel Array |
| 152 | Wind Turbine |
| 154 | AC Power Input |
| 156 | Battery Power Input |
| [symbol] | Airflow |

1. A cylinder-shaped dehumidifier system for extracting water from atmospheric humidity, comprising:
a cylindrical housing defining an internal chamber;
a low-power fan configured to draw humid air into the chamber;
a vortex-inducing airflow pathway within the chamber for circulating the humid air around a central axis;
a condensation coil or rod assembly within the chamber, cooled by a refrigerant loop;
a thermostat and humidity-controlled system configured to regulate refrigerant temperature based on environmental conditions;
a multi-source power system configured to operate using at least one of solar, wind, battery, or standard AC/DC power sources; and
a water collection reservoir positioned at the base of the cylinder to store condensed water droplets.

2. The cylinder-shaped dehumidifier system of claim 1, wherein the cylindrical housing is manufactured in different sizes based on available energy supply and desired water output.

3. The cylinder-shaped dehumidifier system of claim 1, wherein different types of refrigerants are used in the condensation coils or rods based on geographical region and availability of supply.

4. The cylinder-shaped dehumidifier system of claim 1, further comprising a thermostat and humidity sensor configured to prevent coil freezing and maintain operational efficiency in variable climates.

5. The cylinder-shaped dehumidifier system of claim 1, wherein the power system seamlessly switches between multiple energy sources to ensure continuous operation.

6. A method of extracting water from atmospheric humidity, comprising:
drawing humid air into a cylindrical housing;
inducing a vortex airflow pathway around a central condensation coil or rod assembly;
cooling the condensation coil or rods with a regulated refrigerant loop;
condensing water vapor into droplets on the cooled surfaces;
collecting condensed water into a storage reservoir; and
powering the system using solar, wind, battery, or AC/DC electrical sources.

7. The method of claim 6, further comprising regulating coil temperature based on real-time humidity and ambient conditions to improve water extraction efficiency.
